(19) United States
(12) Patent Application Publication
(10) Pub. No.: US 2011/0095057 A1
(43) Pub. Date: Apr. 28, 2011

(54) DRAW-OFF VALVE FOR A DRINKS RESERVOIR, AS WELL AS A DRINKS RESERVOIR PROVIDED WITH A DRAW-OFF VALVE OF THIS TYPE

(75) Inventors: Maximiliaan Noordanus, Noord Scharwoude (NL); Eric Michael Cornelis Maria van Eijnatten, Obdam (NL)

(73) Assignee: BRAVILOR HOLDING B.V., Heerhugowaard (NL)

(21) Appl. No.: 12/094,125

(22) PCT Filed: Nov. 16, 2006
(86) PCT No.: PCT/NL06/50290

§ 371 Date: Mar. 25, 2010

(30) Foreign Application Priority Data
Nov. 17, 2005 (NL) 1030454

(51) Int. Cl. B67D 7/08; A47J 41/00

(52) U.S. Cl. 222/509; 251/324; 222/518

(57) ABSTRACT

A draw-off valve for a drinks reservoir and a drinks reservoir provided with a draw-off valve of this type. The draw-off valve comprises a tubular body, a plunger member, and a spring member. Viewed in the direction of passage, the channel narrows, at an internal narrowing, from a first internal cross section to a second internal cross section; the narrowing forms a seat for the underside, facing the outlet, of the head. The spring member acts with bias, on the one hand, on the tubular body and, on the other hand, on the plunger in order to press the underside of the head against the seat. The seat and the underside of the head are formed in such a way that, when positioned against each other under the influence of the biasing of the spring member, they form a sealing closure of the channel.

The present invention relates to a draw-off valve for a drinks reservoir.

Drinks reservoirs, which are used for the temporary storage of hot drinks such as coffee and tea or cold drinks such as lemonade and fruit juices and for the dispensing thereof into beakers, mugs or cups, are generally known from the prior art. In order to keep the drink hot or cold, these containers are thermally insulated. Thermal insulation is usually provided by means of a layer of insulating material such as cork, polystyrene foam or by means of a double wall, the space between the walls being placed under vacuum. In order to allow the container to be filled with drinks, said container is generally provided on its upper side with an opening. Said opening can be closed by a lid which is configured in such a way that the thermal insulation at the site of the lid is sufficient even in the closed state. In order to pour out the drink present in the reservoir, said reservoir can be tilted until the drink flows out of the same opening as that via which the reservoir is filled. In the case of relatively large drinks reservoirs, this pouring by tilting is not practical. In reservoirs of this type, a pump mechanism is often provided with which the drink can be pumped out of the reservoir. Said pump mechanism is often at least partially accommodated in the lid with which the filling opening is closed. Many examples of pump mechanisms of this type can be found in the prior art. Another possibility is to form on the underside of the reservoir a second opening via which the drink is able to flow out of the container. Said opening is then provided with a draw-off valve with which the outflow of drink can be regulated. Systems of this type comprising a draw-off valve on the underside of the reservoir are particularly suitable for relatively large reservoirs. Examples of these include reservoirs of 2 litres or more, in particular reservoirs of 5-10 litres. Examples of draw-off valves of this type include, for instance, a draw-off channel connected to the underside of the reservoir and wherein a ball valve is provided.

The draw-off valves known from the prior art for drinks reservoirs have various type-specific drawbacks.

In general terms, the invention provides a draw-off valve for a drinks reservoir, the draw-off valve comprising:
a tubular body comprising therein a channel extending from an inlet end to an outlet end;
a plunger comprising a stem and a head, the head being oriented toward the inlet end and the stem extending from the head, through the channel, in the direction of the outlet end;
a spring member
wherein, viewed in the direction of passage, the channel narrows, at an internal narrowing, from a first internal cross section to a second internal cross section;
the internal narrowing forming a seat for the underside, facing the outlet end, of the head;
the plunger being movable back and forth between a closed position wherein the underside of the head rests on the seat and an opened position wherein the underside of the head is located at a distance above the seat;
the spring member acting with bias, on the one hand, on the tubular body and, on the other hand, on the plunger in order to bias the plunger into the closed position;
the seat and the underside of the head being formed in such a way that, when positioned against each other under the influence of the biasing of the spring member, they form a sealing closure of the channel.

The draw-off valve according to the invention has the advantage over, inter alia, known ball valves that, in the closed state, the closure of the channel is ensured much more effectively. That is to say, the spring will press the plunger head against the seat under the influence of the biasing. This will also take place if sediment has formed thereon, as is often the case with coffee. A further advantage of the draw-off valve according to the invention is that when the valve is opened—when the plunger has risen from the seat—the stream of liquid flows along all of the closing faces (i.e. the faces which provide the closure when the valve is closed). Particles of dirt and sediment on the faces are thus rinsed away each time the valve is opened. A self-cleaning effect is provided which benefits hygiene. However, in the case of known ball valves, for example, the closing faces do not enter into contact with the stream of liquid. Dirt will thus not be rinsed away in the case of ball valves. Ball valves will therefore be much more prone to leakage. In order, on the one hand, to ensure effective closure when the draw-off valve is closed and, on the other hand, to ensure effective through-flow when the draw-off valve is opened, it is, in accordance with the invention, advantageous if the first internal cross section is larger, viewed in the transverse direction of the channel, than the head, thus allowing liquid, when the head is raised from the seat, to flow around the head, through the channel.

In general terms, the aim of the present invention is to provide an improved draw-off valve for a drinks reservoir.

According to a first aspect, the aim of the invention is, in particular, to simplify the fitting, including the assembly, of the plunger in the tubular body.

This aim according to the first aspect in achieved, in accordance with Claim 1, by forming the head of the plunger and/or the tubular body in such a way that the plunger can be inserted from the outlet end into the tubular body until the head is located above the seat. This can be achieved by, for example, making the tubular body and/or the head of the plunger from a flexible, compliant and resilient material—such as rubber-like material—or by, for example, configuring the plunger head so as to be collapsible, for example collapsible in the manner of an umbrella. It is thus possible, inter alia, to fit the plunger after the tubular body has already been fitted in a drinks reservoir.

With a view to disassembly, it is also advantageous in this regard if the head of the plunger and the tubular body are formed in such a way that the plunger can be pulled, from a state wherein the plunger is located in the tubular body with the head above the seal, out of the tubularly body in the downstream direction in order to remove the plunger. It is thus possible to remove the plunger and optionally to replace it with a new plunger or to remove the plunger, clean it and reposition it.

According to a second aspect—which can be applied separately from, but more advantageously in combination with, the first aspect—the aim of the invention is, in particular, to configure the plunger as to be simple to operate, thus obviating the need for insertion through the wall of the tubular body into the channel defined thereby or, otherwise, the stream of liquid through components, contacting the channel, for operation of the plunger.

This aim according to the second aspect is achieve, in accordance with Claim 4, as a result of the fact that the stem of the plunger carries, at the downstream end of the stem, a tube part which interlocks non-displaceably with the downstream portion of the tubular body; and as a result of the fact that the tubular body comprises, between on the one hand the seat and on the other hand the site of interlocking of the tube part with the tubular body, a tube zone, the wall of which is formed in such a way that the wall allows an axial shortening of said tube zone when the axial distance between, on the one hand, the seat and, on the other hand, the site of interlocking of the tube part with the tubular body decreases. The plunger can then be operated in a simple manner, for the raising of the plunger head from the seat, by pressing the downstream portion of the tubular body in the direction of the seat.

In order, on the one hand, to obtain a sufficiently rigid plunger and, on the other hand, to prevent the stem of the plunger from excessively impeding the through-flow through the channel in the case of a relatively small channel, it is advantageous, in accordance with the invention, if the stem, over at least a portion of its length, has a cruciform cross section. A further advantage of a cruciform cross section of this type is that the gaps between the ribs of the cross ensure at all times that when the valve is open, a through-flow of the channel is possible via said gaps between the ribs of the cross.

In order to improve centring of the plunger in the channel, the invention provides that the channel forms, downstream of the seat, a guide zone with an internal cross section such that said zone forms a guide for the cruciform cross section of the stem and that the stem is displaceable, in the longitudinal direction of the channel, through the second internal cross section and the guide zone.

According to a further embodiment of the invention, it is advantageous if the tubular body comprises a ventilation passage extending through the wall of the tubular body and opening, downstream of the seat, at a mouth in the channel Air from outside is able to stream via said ventilation passage to the space downstream of the seat. This means that when the valve is closed, air is able to enter the space below the head of the plunger. The formation of any vacuum in said space, which might allow liquid to become trapped, is thus prevented. In order to ensure that all liquid which has flowed out of the reservoir in the channel and has passed the plunger head will be able to flow away at all times out of the draw-off valve, it is advantageous, in accordance with the invention, if, viewed in the longitudinal direction of the channel and in the downstream direction, the distance between the mouth and the seat is at most 40%, preferably at most 30%, of the diameter of the second cross section (or of the smallest internal diameter) of the tubular member. Said distance can, for example, be approximately 15% of the diameter. If the diameter of the second cross section is 20 mm, the mouth of the ventilation passage will be located, at 15%, approximately 3 mm below the seat. The distance between said mouth and the seat can, in practice, also be expressed directly in mm rather than in % with respect to the diameter. It is thus advantageous, in accordance with the invention, if the mouth of the ventilation passage is located at most 8 mm, preferably at most 5 mm, downstream of the seat. The mouth of the ventilation passage can, for example, be located 3.5 mm downstream of the seat.

According to a further embodiment of the invention, the stem of the plunger carries, at the downstream end thereof, a tube part which is accommodated in a substantially interlocking manner in the downstream portion of the tubular body. A tube part of this type will be connected to the stem by arms extending from the stem. Through-flow of the channel is thus possible at the downstream end, on the one hand, while on the other hand the plunger will remain at all times correctly centred at the downstream end. Interlocking reception of the tube part in the tubular body also prevents the passage of liquid between the tube part and the tubular body.

It is in this regard also advantageous, in accordance with the invention, if the tube part interlocks non-displaceably with said downstream portion of the tubular body.

Simple fitting of the plunger is thus possible, wherein the plunger is prevented in each case from being able to travel through the channel of the tubular body. Non-displaceable interlocking of this type can be provided in various ways. Examples include an adhesive bond between the tube part and the tubular body. An adhesive bond of this type is subject in the case of food products, including drinks, to quite a few requirements. According to the invention, non-displaceable interlocking which is very neat with regard to fitting and very reliable with regard to use can be provided by configuring the tube part and the downstream portion of the tubular body in such a way that a recess closed by force in the tube part is formed in said downstream portion of the tubular body. The downstream portion of the tubular body is in this case, in particular, formed from an elastically deformable rubber-like material. This facilitates assembly and provides, in practice, a highly reliable fastening. Additionally or alternatively, non-displaceable interlocking can also reliably be produced by providing a clamping part around the downstream portion of the tubular body in such a way that said downstream portion of the tubular body is clamped to the tube part of the plunger. A clamping part of this type can be a clamping ring, for example a resilient spring washer, extending around the entire tubular body. However, according to the invention, said clamping part can also, in a highly efficient manner, be a sliding part comprising a U-shaped indentation which is slid around the tubular body. The tubular body is, in this case, then not completely surrounded by the clamping part. As will be described hereinafter, the U-shaped sliding part is also highly advantageous with regard to assembly even if the U-shaped part is not clamped but located loose on a projection on the tube.

In order, in this case, to prevent the tubular body from being able to come loose, between the clamping part and the tube part, it is advantageous, in accordance with the invention, if the tube part externally comprises a thickened edge for interlocking with the interior of the channel and if, at least if a clamping part is used, said thickened edge is located upstream of the clamping part.

In a further embodiment of the invention, the spring member is a helical spring, in particular a cylindrical helical spring; the helical spring and the tubular body run concentrically with respect to each other; and the helical spring is provided externally of the tubular body. The spring member is thus held in its entirety outside the channel and said member is unable to enter into contact with the liquid flowing through the channel Contamination of the liquid by the spring is thus prevented and sediment is also prevented from being able to settle on the spring or particles of dirt are prevented from being able to become attached to the spring.

In the case of a helical spring of this type, it is also advantageous, in accordance with the invention, if the tubular body has, downstream of the seat and in the direction of passage of the channel, a first external cross section which narrows, at an external narrowing, to a second external cross section, if the first external cross section is larger than the external cross section of the helical spring and the second external cross section is smaller than the internal cross section of the helical spring; if the one end of the helical spring acts on the tubular body at the external narrowing of the first external cross section to the second external cross section; and if the other end of the helical spring acts on the downstream end of the plunger. It is thus achieved in a simple manner that the spring member can bias the plunger in a closed state.

In the case of a draw-off valve wherein the tube part interlocks non-displaceably with the tubular body, preferably in combination with the above-discussed external narrowing of the tubular body, it is advantageous, in accordance with the invention, if the tubular body comprises between on the one hand the seat, in particular the external narrowing, and on the other hand the site of interlocking of the tube part with the tubular body, a tube zone, the wall of which is formed in such a way that said wall allows an axial shortening of said tube zone, for example in an accordion-like manner, when the axial distance between, on the one hand, the seat and, on the other hand, the site of interlocking of the tube part with the tubular body decreases. It is thus ensured, when the plunger is secured to the tubular body, that the head of the plunger can be raised from the seat by the axial shortening of the tube zone. It is in this case, in accordance with the invention, advantageous if the tube zone is preformed with a circumferential fold along which the wall of the tubular body bends outward.

According to a further embodiment, it is advantageous if the tube part comprises, at the end facing the outlet, at least one projection, such as a radially protruding flange, located outside the tubular body. A projection of this type can act, during the insertion of the plunger into the tubular body, as a stop, so that it is possible precisely to tell whether the plunger has been inserted sufficiently deeply into the tubular body for effective functioning. In addition, a projection of this type will prevent the plunger from accidentally entering the tubular body more deeply during use.

It is also advantageous, in accordance with the invention, if the other end of the helical spring acts on the plunger via said projection, such as the aforementioned protruding flange. The other end of the helical spring can, in this case, engage with the clamping part, wherein the clamping part then presses on the projection and thus causes the helical spring to act on the plunger. However, if the other end of the helical spring engages with the clamping part, it is also possible for the helical spring to act on the plunger not via the protruding flange but rather in a more direct manner, via the clamping of the clamping part to the tube part of the plunger.

With a view to simple assembly, it is advantageous if the internal diameter of the helical spring is larger than the largest external diameter of the tube part; if there is provided a retaining part, such as a U-shaped (including a C-shaped) support part, wherein the tube part can be accommodated and whereon the helical spring can rest; and if the tube part is provided with at least one support member, in such a way that the retaining part can rest thereon under the influence of the treatment of the helical spring. The at least one support member can, in this case, be the aforementioned projection, such as the protruding flange, although the at least one support member can also comprise an annular groove in the external circumference of the tube part, wherein the U-shaped support part can then rest. The U-shaped support part can, for example, be the aforementioned clamping part which, as stated hereinbefore, does not have to be clamped in this regard and can be located entirely loose on the at least one support member (such as a projection). The advantage for assembly is that the tube part can first be fastened to the downstream end of the tubular body, without having recourse to the spring; the helical spring can then be positioned, if it has not already been positioned, around the tubular body; and the spring can then be compressed somewhat to obtain biasing and the U-shaped part can be positioned between the spring and the support member in order then to release the spring.

The draw-off valve according to the invention can be operated in a large number of ways. It is, for example, conceivable for the edge of the cup to be pressed against the lower end of the plunger or a lip formed at the lower end of the plunger and the plunger thus to be pressed upward somewhat. With a view to increased ease of operation, the draw-off valve according to the invention further comprises an operating member with:
a grip part;
an aperture for accommodating the outflow end of the assembly formed by the tubular body and plunger in such a way that a stream of liquid passing through the channel passes the aperture unimpeded;
pivot axis means, such as pins or pin receptacles, which define a pivot centre line for pivoting of the operating member;
wherein the aperture and the grip part are positioned apart from each other in the longitudinal direction of the operating member;
there being provided in the aperture at least one push-up member which is configured to push up from below the assembly formed by the tubular body and plunger when the push-up member moves upward; and
the pivot centre line extending transversely to said longitudinal direction and being located between the grip part and the at least one push-up member in such a way that the downward pivoting of the grip part about the pivot centre line results in upward pivoting of the at least one push-up member.

Manually pressing the grip part downward causes the plunger to be raised somewhat, thus allowing drink to flow away through the draw-off valve.

With a view to simple fitting, including assembly, it is advantageous, in accordance with the invention, if the head of the plunger and/or the tubular body are formed in such a way that the plunger can be inserted from the outlet end into the tubular body until the head is located above the seat. With a view to dismantling it is, in this regard, also advantageous if the head of the plunger and the tubular body are formed in such a way that the plunger can be pulled, from a state wherein the plunger is located in the tubular body with the head above the seat, out of the tubular member in the downstream direction in order to remove the plunger. It is thus possible to remove the plunger and optionally to replace it with a new plunger or to remove the plunger, clean it and reposition it.

In order to provide a steady jet of liquid, i.e. drink, out of the draw-off valve, it is advantageous, in accordance with the invention, if the stem of the plunger extends into the outlet end of the channel and if the downstream end of the plunger tapers in the direction of flow. The downstream end of the plunger is thus used for creating a steady jet of liquid. Subsequent dripping is also substantially reduced in this way.

According to a further advantageous embodiment of the draw-off valve, there is provided through the wall of the tubular body a passage for the connection of a gauge glass, which passage in the channel opens upstream of the seat. A gauge glass known per se can thus be connected to substantially the lowest point of the reservoir.

In order to prevent any relatively large solid particles or skins which may be contained in the drink from entering the channel, it is, in accordance with the invention, advantageous if the tubular body is provided at the inlet end with a screen. A screen of this type is advantageously formed by radial arms extending from the inlet end obliquely counter to the direction of flow. The radial arms form in this case, as it were, an upright cone, the top of which may or may not be removed. Radial arms of this type, running obliquely counter to the direction of flow, counteract clogging of the inlet end by obstructed particles of dirt. The arms are advantageously formed as an integral unit with the tubular body.

The tubular body can, for example, be produced as a moulded product made from a plastics material.

The tubular body according to the invention is, in particular, made from a rubber-like material, such as a natural rubber or an artificial rubber. Rubber-like material has the advantage that it provides at the seat a good sealing effect, that it easily inherently has sufficient flexibility to be able to allow axial shortening of the tubular channel, that there can easily be provided sufficient flexibility to allow the head of the plunger to be able to be pressed through the second cross section for fitting or dismantling.

It is in this regard, in accordance with the invention, also advantageous if the tubular body is provided externally and, viewed in the direction of flow, upstream of the seat with a constricted annular zone for accommodating the edge of a passage formed in the base of the reservoir. A rubber-like material of this type can easily be inserted into the passage in the base of the reservoir, so the constricted annular zone accommodates said edge. Under the influence of the resilient effect of the rubber-like material, an effective seal is provided, in this regard, between the constricted annular zone and the edge of the passage on the base of the reservoir.

According to a further aspect, the invention relates to a drinks reservoir provided with a draw-off valve according to the invention.

The invention also encompasses in this regard, in particular, a drinks reservoir for hot drinks such as coffee, tea or drinking chocolate, which drinks reservoir is provided with a draw-off valve according to the invention.

The invention also encompasses in this regard a drinks reservoir for cold drinks such as lemonade or fruit juice, which drinks reservoir is provided with a draw-off valve according to the invention.

The drinks reservoir according to the invention is advantageously thermally insulated, in particular vacuum-insulated.

In the drinks reservoir according to the invention, the draw-off valve according to the invention is provided, in particular, at the base of the reservoir.

The present invention will be explained in more detail below with reference to an illustrative embodiment represented in the drawings, in which:

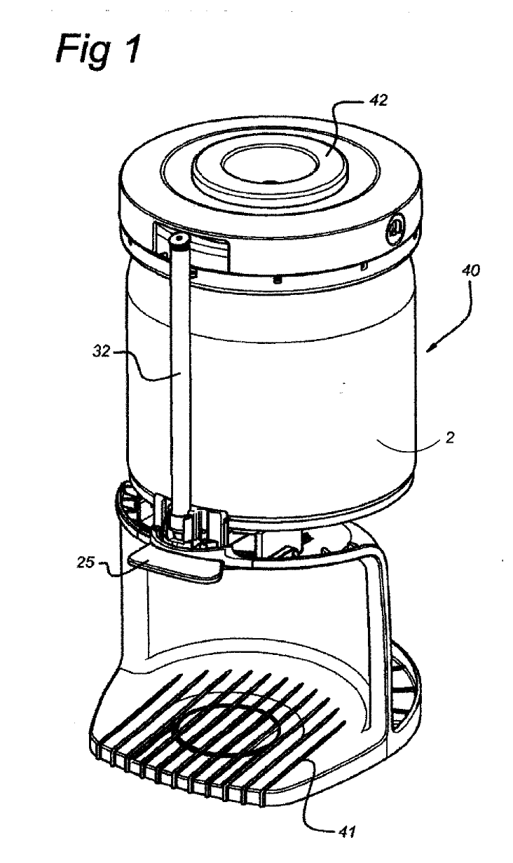

FIG. 1 is a perspective view of a drinks reservoir according to the invention provided with a draw-off valve according to the invention;

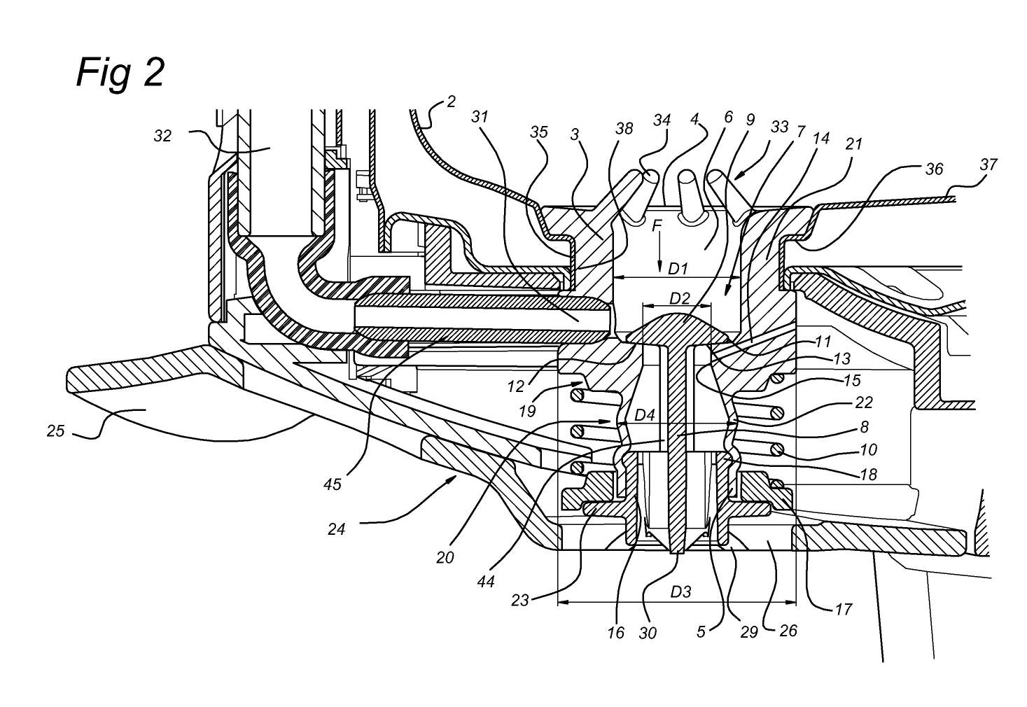

FIG. 2 shows, as a detail from FIG. 1, a sectional view of a draw-off valve according to the invention;

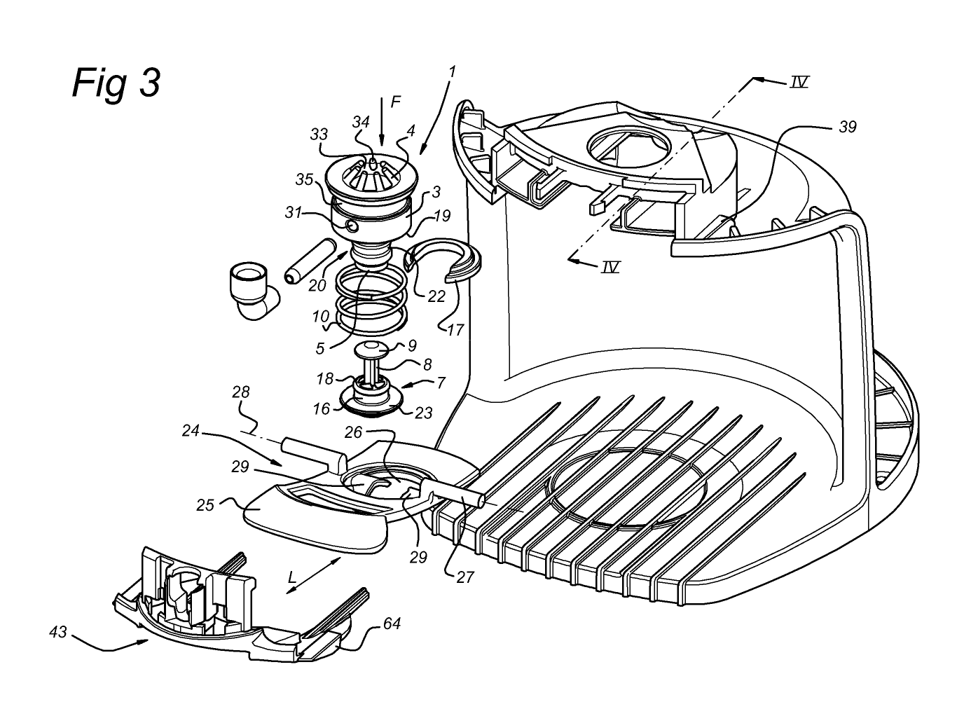

FIG. 3 is an exploded view of a draw-off valve according to the invention;

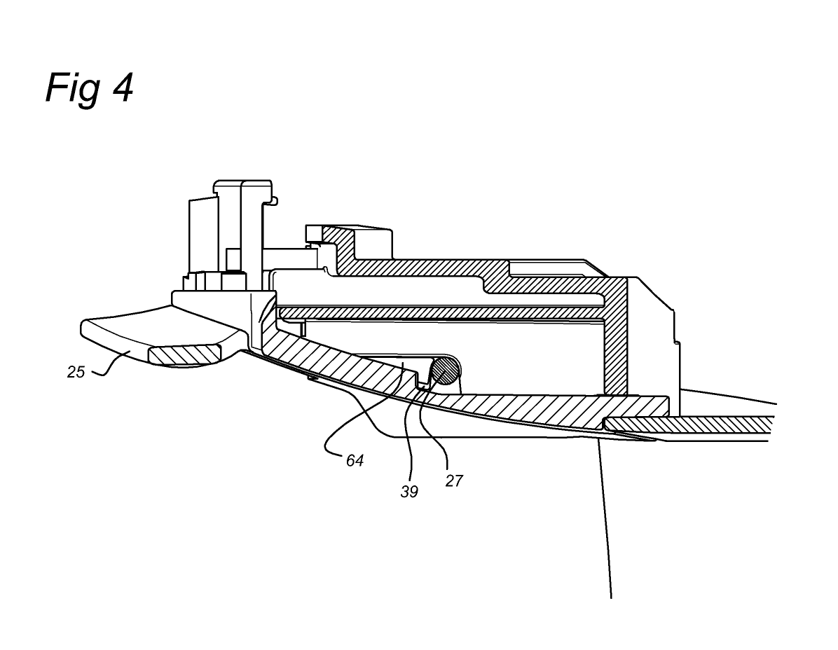

FIG. 4 shows, as a detail and in cross section, a few details of the suspending of the operating member of the draw-off valve as shown in FIGS. 1, 2 and 3.

FIG. 1 shows schematically a drinks dispenser 40 comprising a placement area 41 for the positioning of a cup, mug, etc., and thereabove a vacuum-insulated reservoir 2 for drinks such as coffee. Provided on the upper side is a filling lid 42 which can be unscrewed for filling the reservoir 2 and then screwed down again.

On the front there may be seen a gauge glass 32 known per se, from the prior art, with therebelow the grip portion 25 of an operating member. A draw-off valve according to the invention, fitted on the underside of the reservoir 2, can be operated using said operating member. Said draw-off valve is shown in greater detail in FIGS. 2, 3 and 4.

FIG. 2 is, in this regard, a sectional view, FIG. 3 an exploded view and FIG. 4 a sectional view along the line indicated by the arrows IV-IV in FIG. 3, the draw-off valve itself having been omitted.

The draw-off valve comprises, as its most important components, a tubular body 3, a plunger 7 and a spring member 10.

The tubular body 3 has therein a channel 6 extending from an inlet end 4, facing the interior of the reservoir 2, to an outlet end 5.

The plunger has a stem 8 and a head 9 which is, in this case, specifically mushroom-shaped in its formation. The head 9 is oriented toward the inlet end and the stem 8 extends from the head 9, through the channel 6, in the direction of the outlet end 5.

The channel 6 in the tubular body 3 has an internal narrowing 11, at which location a narrowing from a first internal cross section D₁ to a second internal cross section D₂ takes place. The internal narrowing 11 forms in this regard a seat 12 for the underside 13, facing the outlet end 5, of the head 9 of the plunger 7.

The spring member 10 is, in the closed state of the draw-off valve illustrated in FIG. 2, biased. The spring 10 acts, on the one hand, on the tubular body 3. The spring 10 is set, on its underside, against the external narrowing 19 of the tubular body 3. On the other hand, the spring 10 acts on the plunger 7. This takes place via an intermediate component 17 which [ . . . ] via a radial flange 23 on a tube part 16 carried by the stem 8 of the plunger. The spring member 10 therefore ensures that the underside 13 of the head 9 is pressed onto the seat 12 in order thus to form a sealing closure of the channel Moving the plunger 7 upward somewhat causes the head 9 to come loose of the seat 12 and allows liquid to pass along the head 9 in order to pass through the second internal cross section D₂ and flow to the outlet of the draw-off valve.

In contrast to that which is shown in the figures and will be discussed hereinafter in greater detail, the plunger 7 does not have to be carried or guided by the tubular body 3. The plunger 7 could easily rest on the operating member 24 and could even be guided thereby. It is also entirely possible to support and guide the plunger 7 on other components of the frame of the drinks dispenser 40.

In order to ensure that the drink can easily pass along the head of the plunger when the draw-off valve is opened, the internal cross section D₁ is, as may be seen in FIG. 2, larger than that of the head 9. The liquid is thus able easily to pass around the head 9 when the head 9 is raised from the seat 12.

The stem 8 of the plunger is cruciform in cross section in such a way that there are radially projecting webs 44. The cruciform cross section increases the robustness of the stem without excessively reducing the passage for liquid. The robustness of the stem is important in order to oppose the forces acting thereon during fitting and dismantling of the plunger. Although not applied in this embodiment, the invention also provides for the channel and the cruciform cross section of the stem to have dimensions such that the channel forms, downstream of the seat, at least locally, for example in the portion having diameter D2, a guide for the stem. The stem will then preferably fit without play or almost without play in said portion having diameter D2.

FIG. 2 also shows a ventilation passage 14. Said ventilation passage 14 extends through the wall 21 of the tubular body 3 and has a mouth 15 in the channel 6. Said mouth 15 is located downstream of the seat 12, just below the head 9. As an indication, the distance between the ventilation passage 14 and the seat 12 is approximately 3 mm. This prevents liquid from becoming trapped, under the influence of vacuum effects, in the portion of the channel 6 downstream of the head 9 when the draw-off valve is in the closed state.

At its downstream end, the stem 8 of the plunger 7 carries via radial webs a tube part 16. Said tube part 16 fits in a substantially interlocking manner in the outlet end of the tubular body 3. The tube part 16 is accommodated non-displaceably in the downstream portion of the tubular body 3. This may be achieved by configuring the tip of the tubular body 3 and the tube part 16 in such a way that the tube part 16 fits tightly into the tubular body. The degree of mutual clamping should be sufficiently high to ensure mutual sealing and also to prevent the tube part 16 from accidentally being pressed out of the tubular body by the spring 10. The clamping of the tubular body to the tube part can also, if desired, be provided or additionally assisted by means of the U-shaped part 17 which is, in this case, to be designated as a clamping part. The clamping part 17 has a U-shaped indentation and can thus be slid laterally onto the downstream portion of the tubular body 3 once the tube part 16 has been inserted therein. In order to improve the seizing and fastening of the tube part 16 to the downstream portion of the tubular body 3, the tube part 16 is provided, just above the U-shaped part 17, which may or may not function as a clamping part, with a thickened edge 18. It will be clear that the mutual fastening of the downstream portion of the tubular body 3 to the tube part 16 can also take place in a different manner.

The tube part 16 is also provided with at least one radial projection such as the radially-protruding circumferential flange 23 shown. Said projection 23 has a number of functions which are substantially independent of one another and also do not have to be provided/utilised simultaneously. During insertion of the tube part 16 into the tubular body 3, the projection 23 serves to provide a stop, so it can be ascertained whether, during assembly, the tube part has been inserted sufficiently far into the tubular body 3. The projection 23 further provides, in conjunction with the thickened edge 18, axial enclosure of the U-shaped part 17. The projection 23 also forms a support face for the U-shaped part 17, via which the biasing force of the spring member 10 can be transmitted to the plunger 7.

In this embodiment, the U-shaped part is not as important as the clamping part; it may not even have any clamping function at all. The U-shaped part is particularly advantageous in the assembly of the draw-off tap. The U-shaped part allows the tube part 16 first to be fastened in the tubular body before the spring 10 is tensioned or even fitted. The diameter of the spring 10 is somewhat larger than the diameter of the tube part 16 and the flange 23, so the spring can be slid thereover. The spring is then compressed and the U-shaped part positioned. The U-shaped part is provided with a central thickening for centring the spring and with a central indentation for centring on the flange 23. The U-shaped part 17 can be located entirely loose on the flange 23 without clamping engagement to the tubular body 3. All of the forces of the spring are then transmitted to the tube part 16 via the flange 23.

The tubular body 3 has a tube zone 20, the wall of which is formed in such a way that said tube zone 20 allows an axial shortening when said tube zone is axially compressed. Said tube zone 20 allowing axial shortening is located between, on the one hand, the seat 12 and, on the other hand, the site at which the tube part 16 interlocks with the tubular body 3. It is thus achieved that the draw-off valve can be fitted to the reservoir 2 or can be removed from the reservoir as a single unit. The plunger 7 is carried by the tubular body 3 itself and therefore does not have to be carried by other components of the frame of the drinks dispenser. The movement of the head of the plunger with respect to the seat 12 is rendered possible by the tube zone which allows axial shortening.

The tube zone allowing axial shortening can be produced in a large number of ways. If said tube zone is made from a thin-walled, rubber-like material or, if appropriate, the entire tubular body 3 is made from a rubber-like material, said axial shortening is permitted of its own accord. The axial shortening may be carried out in a more effectively controlled manner if the axial shortenable tube zone is preformed with a circumferential fold 22, along which the wall of the tubular body 3 bends outward in said zone. Ensuring that the plunger, fastened to the lower end of the tubular body 3, is inserted sufficiently far into the tubular body (the flange 23 can be used in this regard as a stop for the outlet end of the tubular body 3) allows the fold to be maintained even in the closed state of the valve. After all, the head of the plunger will rest on the seat 12 and thus prevent the spring member 10 from pressing the plunger too far downward, so that it would stretch the wall of the shortenable tube zone.

The tube zone allowing axial shortening could also be configured, inter alia, in the manner of an accordion.

The spring member can, as such, be configured in a large number of ways. However, it is, in accordance with the invention, advantageous if a simple cylindrical helical spring is used for this purpose. Providing the tubular body 3, downstream of the seat 12, with an external narrowing from a first external cross section D₃ to a second external cross section D₄ produces in a simple manner a suitable site for setting against the cylindrical helical spring. The underside of the cylindrical helical spring 10 will be able to rest on the U-shaped part 17 or, if there is no U-shaped part 17, on the flange 23 or another projection provided for this purpose on the plunger 7. In the illustrated embodiment, the helical spring is positioned entirely outside the channel, and this benefits the hygiene and the cleaning of the system. In the illustrated embodiment, the liquid flowing through the draw-off tap will contact only the tubular body 3 and the plunger 7.

The draw-off valve according to the invention can, as such, be operated in a large number of ways for the opening process. This can take place even without the provision of any specific operating member whatsoever. The plunger would simply have to be able to be raised, using the edge of the cup to be filled, for example by positioning the edge of the cup against the flange 23 or the lower edge of the tube part 16. However, with a view to a high degree of ease of operation, a separate operating member is preferably provided.

In the embodiment shown, the operating member, which is illustrated separately in perspective in FIG. 3, consists of a substantially plate-like body having at one end a grip part 25 and, set apart therefrom in the longitudinal direction, an aperture 26 for accommodating the outflow end of the assembly formed by the tubular body 3 and the plunger 7. Said aperture 26 is configured in such a way that a stream of liquid passing through the channel 6 will not be impeded by said aperture 26, i.e. the stream of liquid is able to pass said aperture 26 freely. Provided in the aperture are two opposing push-up members 29. Said push-up members 29 are located, in the assembled state, against the underside of the flange 23 of the plunger. The operating member 24 is further provided with two pins 27 disposed colinearly with a common pivot centre line 28. Viewed in the longitudinal direction L of the operating member, which longitudinal direction extends transversely to said pivot centre line 28, the pins 27 are located between the face of contact between the push-up members 29 and the plunger, on the one hand, and the grip part 25, on the other hand. It is thus achieved that downward pivoting of the grip part 25 about the pivot centre line 28 results in upward pivoting of the contact faces of the push-up members 29, thus causing the plunger 7 to be pushed upward, so the head 9 thereof is released from the seat 12. It will be noted that the pins 27 can also be removed further from the grip part 25 than the contact faces of the push-up members 29. In that case, the grip part 25 will have to be pivoted upward in order to cause the push-up members 29 to move upward for the raising of the head 9 from the seat 12. This is less preferred from the point of view of ease of operation.

With reference to FIGS. 3 and 4, it can be seen the frame of the drinks dispenser is provided with two points 39 for placement of the pins 27. Said placement points 39 are grooves opening substantially in the direction of the grip part 25. The operating member 24 can therefore be fitted in a simple manner by thus sliding the operating member into the grooves 39. In order to prevent the pins 27 from becoming detached from said grooves 39, there is additionally provided a further retaining member 43 comprising two legs 64 which may or may not be provided with springs and are also inserted into the grooves 39 in order to hold the pins 27 in position.

With reference to FIGS. 2 and 3, it may also be seen that the tubular body 3 is provided with a passage 31 which opens upstream of the seat 12. A valve boss for a gauge glass 32 known per se can be inserted into said passage 31.

Referring back, in particular, to FIGS. 2 and 3, it may be seen that the tubular body 3 is provided, at the inlet 4, with a screen 33 in the form of radially, obliquely protruding fingers 34. Said fingers prevent relatively large particles of dirt or skins from being able to enter the draw-off valve. The fact that the arms 34 rise obliquely allows relatively large particles of dirt of this type to be obstructed more or less laterally of the arms 34 and the capacity of the screen 33 to be passed through from above to remain ensured for longer.

Configuring the plunger head 9 in the shape of a mushroom allows, in combination with the making of the tubular body from a rubber-like material, the plunger 7 to be inserted into the tubular body 3 from the outlet end in a direction opposing the direction of flow (arrow F). The mushroom shape of the head 9 allows the head 9 to pass through the passage D₂, which is narrower than the head 9. Said mushroom shape also allows the plunger to be removed from the tubular body 3 by pulling said body downward in the direction of flow (arrow F). These aspects are useful when cleaning the draw-off valve according to the invention and also in other forms of maintenance, for example for replacing the plunger.

It may also be seen, in particular, in FIG. 2 that the tubular body 3, close to the inlet 4, is provided with a constriction zone 35 wherein the edge 36 is accommodated around a passage 38 and the base 37 of the reservoir 2. Making the tubular body 3 from a rubber-like material thus provides in a simple manner and without any further measures effective sealing of the draw-off valve and the base of the reservoir. It is also easily possible to remove the tubular body 3 from the base and reposition it in order, if necessary, to replace the entire draw-off valve.

The fact that apart from the tubular body and the plunger, no further parts of the draw-off valve enter into contact with the drink means that the associated problems concerning hygiene and the like also remain restricted to these two parts. In the case of the remaining parts other than the spring and retaining part (17), the choice of material and shape can be determined purely by the functions, and shape and material regulations regarding food safety can be disregarded.

Furthermore, the draw-off valve is actually attached in the wall of the drinks reservoir and not set apart therefrom as a stand-alone unit, thus obviating the need for feed or discharge pipes which make the construction of a coffee container generally much more complex. This in itself simplifies fitting and dismantling and thus also the maintenance of the unit.

1-37. (canceled)

38. A draw-off valve for a drinks reservoir, the draw-off valve comprising:
a tubular body comprising therein a channel extending from an inlet end to an outlet end;
a plunger comprising a stem and a head, the head being oriented toward the inlet end and the stem extending from the head, through the channel, in the direction of the outlet end;
a spring member;
wherein, viewed in the direction of passage, the channel narrows, at an internal narrowing, from a first internal cross section diameter to a second internal cross section diameter;
the internal narrowing forming a seat for the underside, facing the outlet end, of the head;
the plunger being movable back and forth between a closed position wherein the underside of the head rests on the seat and an opened position wherein the underside of the head is located at a distance above the seat;
the spring member acting with bias, on the one hand, on the tubular body and, on the other hand, on the plunger in order to bias the plunger into the closed position;
the seat and the underside of the head being formed in such a way that, when positioned against each other under the influence of the biasing of the spring member, they form a sealing closure of the channel; and
the head of the plunger and/or the tubular body being formed in such a way that the plunger can be inserted from the outlet end into the tubular body until the head is located above the seat.

39. The draw-off valve according to claim 38, wherein the head of the plunger and/or the tubular body are formed in such a way that the plunger can be pulled, from a state wherein the plunger is located in the tubular body with the head above the seat, in the downstream direction out of the tubular body in order to remove the plunger.

40. The draw-off valve according to claim 38, wherein:
the stem of the plunger carries, at the downstream end of the stem, a tube part which interlocks non-displaceably with the downstream portion of the tubular body;
the tubular body comprising, between on the one hand the seat, in particular the external narrowing, and on the other hand the site of interlocking of the tube part with the tubular body, a tube zone, the wall of which is formed in such a way that said wall allows an axial shortening of said tube zone when the axial distance between, on the one hand, the seat and, on the other hand, the site of interlocking of the tube part with the tubular body decreases.

41. A draw-off valve for a drinks reservoir, the draw-off valve comprising:
a tubular body comprising therein a channel extending from an inlet end to an outlet end;
a plunger comprising a stem and a head, the head being oriented toward the inlet end and the stem extending from the head, through the channel, in the direction of the outlet end;
a spring member;
wherein, viewed in the direction of passage, the channel narrows, at an internal narrowing, from a first internal cross section diameter to a second internal cross section diameter;
the internal narrowing forming a seat for the underside, facing the outlet end, of the head;
the plunger being movable back and forth between a closed position wherein the underside of the head rests on the seat and an opened position wherein the underside of the head is located at a distance above the seat;
the spring member acting with bias, on the one hand, on the tubular body and, on the other hand, on the plunger in order to bias the plunger into the closed position;
the seat and the underside of the head being formed in such a way that, when positioned against each other under the influence of the biasing of the spring member, they form a sealing closure of the channel;
the stem of the plunger carrying, at the downstream end of the stem, a tube part which interlocks non-displaceably with the downstream portion of the tubular body;
the tubular body comprising, between on the one hand the seat, in particular the external narrowing, and on the other hand the site of interlocking of the tube part with the tubular body, a tube zone, the wall of which is formed in such a way that said wall allows an axial shortening of said tube zone when the axial distance between, on the one hand, the seat and, on the other hand, the site of interlocking of the tube part with the tubular body decreases.

42. The draw-off valve according to claim 41, wherein the tube zone is formed in the manner of an accordion.

43. The draw-off valve according to claim 41, wherein said tube zone is preformed with a circumferential fold along which the wall of the tubular body bends outward.

44. The draw-off valve according to claim 41, wherein:
the spring member is a helical spring, in particular a cylindrical helical spring;
the helical spring and the tubular body running concentrically with respect to each other; and
the helical spring being provided externally of said tubular body.

45. The draw-off valve according to claim 44, wherein:
the tubular body has, downstream of the seat and in the direction of passage of the channel, a first external cross section which narrows, at an external narrowing, to a second external cross section;
the first external cross section being larger than the external cross section of the helical spring and the second external cross section being smaller than the internal cross section of the helical spring;
the one end of the helical spring acting on the tubular body at the external narrowing; and
the other end of the helical spring acting on the downstream end of the plunger.

46. The draw-off valve according to claim 41, wherein the tube part comprises, at the outlet end, at least one projection, such as a radially protruding flange, which projection is located outside the tubular body.

47. The draw-off valve according to claim 46, wherein the other end of the helical spring acts on the plunger via said projection.

48. The draw-off valve according to claim 44, wherein:
the internal diameter of the helical spring is larger than the largest external diameter of the tube part;
a retaining part being provided wherein the tube part can be accommodated and whereon the other end of the helical spring can rest; and
the tube part being provided with at least one support member whereon the retaining part can rest under the influence of the treatment of the helical spring.

49. The draw-off valve according to claim 41, wherein the stem of the plunger carries, at the downstream end thereof, a tube part which is accommodated in a substantially interlocking manner in the downstream portion of the tubular body.

50. The draw-off valve according to claim 41, wherein the tube part and the downstream portion of the tubular body are configured in such a way that a recess closed by force in the tube part can be formed in said downstream portion of the tubular body.

51. The draw-off valve according to claim 47, wherein the downstream portion of the tubular body is formed by an elastically deformable rubber-like material.

52. The draw-off valve according to claim 41, further comprising a clamping part provided around the downstream portion of the tubular body in such a way that said downstream portion of the tubular body is clamped to the tube part of the plunger.

53. The draw-off valve according to claim 41, wherein said tube part externally comprises a thickened edge for interlocking with the interior of the channel.

54. The draw-off valve according to claim 41, wherein the head of the plunger and the tubular body are formed in such a way that the plunger can be inserted from the outlet end into the tubular body until the head is located above the seat.

55. The draw-off valve according to claim 54, wherein the head of the plunger and the tubular body are formed in such a way that the plunger can be pulled, from a state wherein the plunger is located in the tubular body with the head above the seat, in the downstream direction out of the tubular body in order to remove the plunger.

56. The draw-off valve according to claim 41, wherein the first internal cross section diameter is larger, viewed in the transverse direction of the channel, than the head in such a way that when the head of the seat is raised, liquid is able to flow around the head, through the channel.

57. The draw-off valve according to claim 41, wherein the stem has, over at least a portion of its length, a cruciform cross section.

58. The draw-off valve according to claim 57, wherein the channel has, downstream of the seat, a guide zone with an internal cross section such that said zone forms a guide for the cruciform cross section of the stem and wherein the stem is displaceable, in the longitudinal direction of the channel, through the second internal cross section and the guide zone.

59. The draw-off valve according to claim 41, wherein the tubular body comprises a ventilation passage extending through the wall of the tubular body and opening, downstream of the seat, at a mouth in the channel.

60. The draw-off valve according to claim 59, wherein the mouth of the ventilation passage is located at most 8 mm, preferably at most 5 mm, for example 3.5 mm, downstream of the seat.

61. The draw-off valve according to claim 59, wherein, viewed in the longitudinal direction of the channel and in the downstream direction, the mouth is at a distance from the seat which is at most 40%, preferably at most 30%, for example approximately 15%, of the smallest internal diameter of the tubular body.

62. The draw-off valve according to claim 41, further comprising an operating member with:
a grip part;
an aperture for accommodating the outflow end of the assembly formed by the tubular body and plunger in such a way that a stream of liquid passing through the channel passes the aperture unimpeded;
pivot axis means, such as pins or pin receptacles, which define a pivot centre line for pivoting of the operating member;
wherein the aperture and the grip part are positioned apart from each other in the longitudinal direction of the operating member;
there being provided in the aperture at least one push-up member which is configured to push up from below the assembly formed by the tubular body and plunger when the push-up member moves upward; and
the pivot centre line extending transversely to said longitudinal direction and being located between the grip part and the at least one push-up member in such a way that the downward pivoting of the grip part about the pivot centre line results in upward pivoting of the at least one push-up member.

63. The draw-off valve according to claim 41, wherein the stem of the plunger extends into the outlet end of the channel and wherein the downstream end of the stem tapers in the direction of flow.

64. The draw-off valve according to claim 41, wherein there is provided through the wall of the tubular body a passage for the connection of a gauge glass, which passage in the channel opens upstream of the seat.

65. The draw-off valve according to claim 41, wherein the tubular body is provided, at the inlet end, with a screen.

66. The draw-off valve according to claim 65, wherein the screen is formed by radial arms extending from the inlet end obliquely counter to the direction of flow.

67. The draw-off valve according to claim 66, wherein said arms are formed as an integral unit with the tubular body.

68. The draw-off valve according to claim 41, wherein the tubular body is made from a rubber-like material.

69. The draw-off valve according to claim 68, wherein the tubular body is provided externally and, viewed in the direction of flow, upstream of the seat with a constricted annular zone for accommodating the edge of a passage formed in the base of the reservoir.

70. A drinks reservoir including a draw-off valve comprising:
a tubular body comprising therein a channel extending from an inlet end to an outlet end;
a plunger comprising a stem and a head, the head being oriented toward the inlet end and the stem extending from the head, through the channel, in the direction of the outlet end;
a spring member;
wherein, viewed in the direction of passage, the channel narrows, at an internal narrowing, from a first internal cross section diameter to a second internal cross section diameter;
the internal narrowing forming a seat for the underside, facing the outlet end, of the head;
the plunger being movable back and forth between a closed position wherein the underside of the head rests on the seat and an opened position wherein the underside of the head is located at a distance above the seat;
the spring member acting with bias, on the one hand, on the tubular body and, on the other hand, on the plunger in order to bias the plunger into the closed position;
the seat and the underside of the head being formed in such a way that, when positioned against each other under the influence of the biasing of the spring member, they form a sealing closure of the channel;
the stem of the plunger carrying, at the downstream end of the stem, a tube part which interlocks non-displaceably with the downstream portion of the tubular body;
the tubular body comprising, between on the one hand the seat, in particular the external narrowing, and on the other hand the site of interlocking of the tube part with the tubular body, a tube zone, the wall of which is formed in such a way that said wall allows an axial shortening of said tube zone when the axial distance between, on the one hand, the seat and, on the other hand, the site of interlocking of the tube part with the tubular body decreases.

71. A drinks reservoir for hot drinks such as coffee, tea or drinking chocolate, which drinks reservoir includes a draw-off valve comprising:
a tubular body comprising therein a channel extending from an inlet end to an outlet end;
a plunger comprising a stem and a head, the head being oriented toward the inlet end and the stem extending from the head, through the channel, in the direction of the outlet end;
a spring member;
wherein, viewed in the direction of passage, the channel narrows, at an internal narrowing, from a first internal cross section diameter to a second internal cross section diameter;
the internal narrowing forming a seat for the underside, facing the outlet end, of the head;
the plunger being movable back and forth between a closed position wherein the underside of the head rests on the seat and an opened position wherein the underside of the head is located at a distance above the seat;
the spring member acting with bias, on the one hand, on the tubular body and, on the other hand, on the plunger in order to bias the plunger into the closed position;
the seat and the underside of the head being formed in such a way that, when positioned against each other under the influence of the biasing of the spring member, they form a sealing closure of the channel;
the stem of the plunger carrying, at the downstream end of the stem, a tube part which interlocks non-displaceably with the downstream portion of the tubular body;
the tubular body comprising, between on the one hand the seat, in particular the external narrowing, and on the other hand the site of interlocking of the tube part with the tubular body, a tube zone, the wall of which is formed in such a way that said wall allows an axial shortening of said tube zone when the axial distance between, on the one hand, the seat and, on the other hand, the site of interlocking of the tube part with the tubular body decreases.

72. A drinks reservoir for cold drinks such as lemonade or fruit juice, which drinks reservoir includes a draw-off valve comprising
a tubular body comprising therein a channel extending from an inlet end to an outlet end;
a plunger comprising a stem and a head, the head being oriented toward the inlet end and the stem extending from the head, through the channel, in the direction of the outlet end;
a spring member;
wherein, viewed in the direction of passage, the channel narrows, at an internal narrowing, from a first internal cross section diameter to a second internal cross section diameter;
the internal narrowing forming a seat for the underside, facing the outlet end, of the head;
the plunger being movable back and forth between a closed position wherein the underside of the head rests on the seat and an opened position wherein the underside of the head is located at a distance above the seat;
the spring member acting with bias, on the one hand, on the tubular body and, on the other hand, on the plunger in order to bias the plunger into the closed position;
the seat and the underside of the head being formed in such a way that, when positioned against each other under the influence of the biasing of the spring member, they form a sealing closure of the channel;
the stem of the plunger carrying, at the downstream end of the stem, a tube part which interlocks non-displaceably with the downstream portion of the tubular body;
the tubular body comprising, between on the one hand the seat, in particular the external narrowing, and on the other hand the site of interlocking of the tube part with the tubular body, a tube zone, the wall of which is formed in such a way that said wall allows an axial shortening of said tube zone when the axial distance between, on the one hand, the seat and, on the other hand, the site of interlocking of the tube part with the tubular body decreases.

73. A drinks reservoir according to claim 70, wherein the reservoir is thermally insulated, in particular vacuum-insulated.

74. A drinks reservoir according to claim 70, wherein the draw-off valve is provided at the base of the reservoir.

75. The draw-off valve according to claim 38, wherein the tube zone is formed in the manner of an accordion.

76. The draw-off valve according to claim 38, wherein said tube zone is preformed with a circumferential fold along which the wall of the tubular body bends outward.

77. The draw-off valve according to claim 38, wherein:
the spring member is a helical spring, in particular a cylindrical helical spring;
the helical spring and the tubular body running concentrically with respect to each other; and
the helical spring being provided externally of said tubular body.

78. The draw-off valve according to claim 77, wherein:
the tubular body has, downstream of the seat and in the direction of passage of the channel, a first external cross section which narrows, at an external narrowing, to a second external cross section;
the first external cross section being larger than the external cross section of the helical spring and the second external cross section being smaller than the internal cross section of the helical spring;
the one end of the helical spring acting on the tubular body at the external narrowing; and
the other end of the helical spring acting on the downstream end of the plunger.

79. The draw-off valve according to claim 38, wherein the tube part comprises, at the outlet-side end, at least one projection, such as a radially protruding flange, which projection is located outside the tubular body.

80. The draw-off valve according to claim 79, wherein the other end of the helical spring acts on the plunger via said projection.

81. The draw-off valve according to claim 77, wherein:
the internal diameter of the helical spring is larger than the largest external diameter of the tube part;
a retaining part being provided wherein the tube part can be accommodated and whereon the other end of the helical spring can rest; and
the tube part being provided with at least one support member whereon the retaining part can rest under the influence of the treatment of the helical spring.

82. The draw-off valve according to claim 38, wherein the stem of the plunger carries, at the downstream end thereof, a tube part which is accommodated in a substantially interlocking manner in the downstream portion of the tubular body.

83. The draw-off valve according to claim 38, wherein the tube part and the downstream portion of the tubular body are configured in such a way that a recess closed by force in the tube part can be formed in said downstream portion of the tubular body.

84. The draw-off valve according to claim 47, wherein the downstream portion of the tubular body is formed by an elastically deformable rubber-like material.

85. The draw-off valve according to claim 38, further comprising a clamping part provided around the downstream portion of the tubular body in such a way that said downstream portion of the tubular body is clamped to the tube part of the plunger.

86. The draw-off valve according to claim 38, wherein said tube part externally comprises a thickened edge for interlocking with the interior of the channel.

87. The draw-off valve according to claim 38, wherein the first internal cross section is larger, viewed in the transverse direction of the channel, than the head in such a way that when the head of the seat is raised, liquid is able to flow around the head, through the channel.

88. The draw-off valve according to claim 38, wherein the stem has, over at least portion of its length, a cruciform cross section.

89. The draw-off valve according to claim 88, wherein the channel has, downstream of the seat, a guide zone with an internal cross section such that said zone forms a guide for the cruciform cross section of the stem and wherein the stem is displaceable, in the longitudinal direction of the channel, through the second internal cross section and the guide zone.

90. The draw-off valve according to claim 38, wherein the tubular body comprises a ventilation passage extending through the wall of the tubular body and opening, downstream of the seat, at a mouth in the channel.

91. The draw-off valve according to claim 90, wherein the mouth of the ventilation passage is located at most 8 mm, preferably at most 5 mm, for example 3.5 mm, downstream of the seat.

92. The draw-off valve according to claim 90, wherein, viewed in the longitudinal direction of the channel and in the downstream direction, the mouth is at a distance from the seat which is at most 40%, preferably at most 30%, for example approximately 15%, of the smallest internal diameter of the tubular body.

93. The draw-off valve according to claim 38, further comprising an operating member with:
a grip part;
an aperture for accommodating the outflow end of the assembly formed by the tubular body and plunger in such a way that a stream of liquid passing through the channel passes the aperture unimpeded;
pivot axis means, such as pins or pin receptacles, which define a pivot centre line for pivoting of the operating member;
wherein the aperture and the grip part are positioned apart from each other in the longitudinal direction of the operating member;
there being provided in the aperture at least one push-up member which is configured to push up from below the assembly formed by the tubular body and plunger when the push-up member moves upward; and
the pivot centre line extending transversely to said longitudinal direction and being located between the grip part and the at least one push-up member in such a way that the downward pivoting of the grip part about the pivot centre line results in upward pivoting of the at least one push-up member.

94. The draw-off valve according to claim 38, wherein the stem of the plunger extends into the outlet end of the channel and wherein the downstream end of the stem tapers in the direction of flow.

95. The draw-off valve according to claim 38, wherein there is provided through the wall of the tubular body a passage for the connection of a gauge glass, which passage in the channel opens upstream of the seat.

96. The draw-off valve according to claim 38, wherein the tubular body is provided, at the inlet end, with a screen.

97. The draw-off valve according to claim 96, wherein the screen is formed by radial arms extending from the inlet end obliquely counter to the direction of flow.

98. The draw-off valve according to claim 97, wherein said arms are formed as an integral unit with the tubular body.

99. The draw-off valve according to claim 38, wherein the tubular body is made from a rubber-like material.

100. The draw-off valve according to claim 99, wherein the tubular body is provided externally and, viewed in the direction of flow, upstream of the seat with a constricted annular zone for accommodating the edge of a passage formed in the base of the reservoir.

101. A drinks reservoir including a draw-off valve comprising:
a tubular body comprising therein a channel extending from an inlet end to an outlet end;
a plunger comprising a stem and a head, the head being oriented toward the inlet end and the stem extending from the head, through the channel, in the direction of the outlet end;
a spring member;
wherein, viewed in the direction of passage, the channel narrows, at an internal narrowing, from a first internal cross section diameter to a second internal cross section diameter;
the internal narrowing forming a seat for the underside, facing the outlet end, of the head;
the plunger being movable back and forth between a closed position wherein the underside of the head rests on the seat and an opened position wherein the underside of the head is located at a distance above the seat;
the spring member acting with bias, on the one hand, on the tubular body and, on the other hand, on the plunger in order to bias the plunger into the closed position;
the seat and the underside of the head being formed in such a way that, when positioned against each other under the influence of the biasing of the spring member, they form a sealing closure of the channel; and
the head of the plunger and/or the tubular body being formed in such a way that the plunger can be inserted from the outlet end into the tubular body until the head is located above the seat.

102. A drinks reservoir for hot drinks such as coffee, tea or drinking chocolate, which drinks reservoir includes a draw-off valve comprising:
a tubular body comprising therein a channel extending from an inlet end to an outlet end;
a plunger comprising a stem and a head, the head being oriented toward the inlet end and the stem extending from the head, through the channel, in the direction of the outlet end;
a spring member;
wherein, viewed in the direction of passage, the channel narrows, at an internal narrowing, from a first internal cross section diameter to a second internal cross section diameter;
the internal narrowing forming a seat for the underside, facing the outlet end, of the head;
the plunger being movable back and forth between a closed position wherein the underside of the head rests on the seat and an opened position wherein the underside of the head is located at a distance above the seat;
the spring member acting with bias, on the one hand, on the tubular body and, on the other hand, on the plunger in order to bias the plunger into the closed position;
the seat and the underside of the head being formed in such a way that, when positioned against each other under the influence of the biasing of the spring member, they form a sealing closure of the channel; and
the head of the plunger and/or the tubular body being formed in such a way that the plunger can be inserted from the outlet end into the tubular body until the head is located above the seat.

103. A drinks reservoir for cold drinks such as lemonade or fruit juice, which drinks reservoir includes a draw-off valve comprising a tubular body comprising therein a channel extending from an inlet end to an outlet end;
a plunger comprising a stem and a head, the head being oriented toward the inlet end and the stem extending from the head, through the channel, in the direction of the outlet end;
a spring member;
wherein, viewed in the direction of passage, the channel narrows, at an internal narrowing, from a first internal cross section diameter to a second internal cross section diameter;
the internal narrowing forming a seat for the underside, facing the outlet end, of the head;
the plunger being movable back and forth between a closed position wherein the underside of the head rests on the seat and an opened position wherein the underside of the head is located at a distance above the seat;
the spring member acting with bias, on the one hand, on the tubular body and, on the other hand, on the plunger in order to bias the plunger into the closed position;
the seat and the underside of the head being formed in such a way that, when positioned against each other under the influence of the biasing of the spring member, they form a sealing closure of the channel; and
the head of the plunger and/or the tubular body being formed in such a way that the plunger can be inserted from the outlet end into the tubular body until the head is located above the seat.
